(19) United States
(12) Patent Application Publication
(10) Pub. No.: US 2015/0075514 A1
(43) Pub. Date: Mar. 19, 2015

(54) Collapsible Fire Pit And Grill In One Assembly

(71) Applicant: James D. Kuenzinger, Santa Maria, CA (US)

(72) Inventor: James D. Kuenzinger, Santa Maria, CA (US)

(21) Appl. No.: 14/030,596

(22) Filed: Sep. 18, 2013

(51) Int. Cl. A47J 37/07

(52) U.S. Cl. CPC A47J 37/0763
USPC 126/25 A; 126/9 B

(57) ABSTRACT

A collapsible fire pit and grill in one assembly is disclosed which includes a fire pit, a removable grill sized over the top of the fire pit, a rotational pulley system for easily adjusting the distance from the grill to the top of the fire pit. The fire pit and grill assembly of the present invention offers a relaxing atmosphere of an outdoor fire and quickly and easily convert to a fully adjustable cook height grill using a rotational pulley system. The fire pit and grill assembly may collapse down to approximately 11 inches in height to save space for stowing away and easy transportation.

### BACKGROUND OF THE INVENTION

1. Field of the Invention

The present invention relates to a portable fire pit and grill in one assembly and more particularly, to a portable and collapsible fire pit and grill in one assembly that offers a relaxing atmosphere of an outdoor fire and quickly and easily convert to a fully adjustable cook height grill using a rotational pulley system.

2. Description of Related Art

When conducting outdoor activities, such as camping, hiking, people enjoy camp fire pit for warming up or grill. Portable fireplaces and fire pits are used by campers and homeowners to provide outdoor heat and the pleasant appearance of a wood fire. Grills are employed for outdoor cooking. Current grills and fire pits are bulky and hard to carry. It is troublesome and takes up too much valuable space to carry both a fire pit and a grill in RV. Furthermore, currently, the grill master has to grill alone.

Therefore, there is a need to combine the grill and fire pit in a single compact easy-to-carry, easy-to-set up, easy-to-convert and easy to use assembly.

### SUMMARY OF THE INVENTION

One object of the present invention is to provide a grilling apparatus that is designed to be quickly, easily set up, and can be used where open fires need to be contained.

Another object of the present invention is to provide a grilling apparatus that can collapse so it can be easily stored in the storage compartment of a vehicle, conveniently stowed on a shelf in the garage, hung on the garage wall when not in use and easily carried and transported.

A further object of the present invention is to provide a combination assembly that can be easily transformed from a grilling mode to the fire pit mode to provide outdoor heat and the pleasant appearance of a wood fire as part of the patio decor.

Still another object of the present invention is to provide an apparatus with a design that eliminates bulky size or having to carry such a bulky apparatus.

In an exemplary embodiment of the present invention, there is disclosed a collapsible fire pit and grill in one single unit which includes a cylindrical shaped fire pit, a removable grill sized to fit over the top of the fire pit, a rotational pulley system for converting an outdoor fire pit to a fully adjustable cook height grill. The rotational pulley system having two parallel vertical sections inserted into the brackets in the grill and fire pit and a handle to pull and release the cable so as to adjust the height of the grill relative to the fire pit.

The collapsible grill and fire pit in one assembly may collapse down to approximately 11 inches in height to save space for stowing away. The legs on the base of the collapsible grill and fire pit in one assembly can be folded up against the base of the fire pit. The pulley system's U-shaped frame's two vertical section (beams) may be pulled out from the grill's brackets. The whole rotational pulley system may be laid flat on top of the grill and fire pit to save space for stowing away.

The rotational pulley system's handle may also be collapsed down. There are two ways of doing this. One way is a handle that rotates at the hinge that can be rotated to a tuck away position for easier stowing away. A second way is a handle that is locked in place by a locking pin where the handle is detached when the locking pin is removed.

With the present invention, the grill master no longer has to grill alone. He can become a guest at his own party while he grills. The present invention could be used at home and is easily picked up to take around in an RV. With the present invention, the user can enjoy a relaxing atmosphere of an outdoor fire and quickly and easily convert it to a fully adjustable cook height grill. It is simple and easy to use for everyone and is designed to be virtually indestructible.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an isometric view of the collapsible grill and fire pit in one assembly.

FIG. 2 is an isometric view of the collapsible grill and fire pit in one assembly in the folded/collapsed form.

FIG. 3 is a top view of the collapsible grill and fire pit in one assembly in the folded/collapsed form.

FIG. 4 is a side view of the collapsible grill and fire pit in one assembly in the folded/collapsed form.

FIG. 5 is an isometric view of the collapsible grill and fire pit in one assembly in the folded/collapsed form placed in a box for convenient storage.

FIG. 6 is an isometric view of the fire pit.

FIG. 7 is an isometric view of the base of the fire pit showing the legs mounted with hinges in standing position.

FIG. 8 is an isometric view of the base of the fire pit showing the leg rotated about the hinge and stowed against the base of the fire pit.

FIG. 9 is an isometric view of the rotational pulley assembly.

FIG. 10 is a zoom in view of the handle with locking collar.

FIG. 11 is a zoom in view of the handle with the collar pushed back, exposing the hinge, and placing the handle in rotated position.

FIG. 12 is a zoom in top view of the handle with collar pushed back exposing the hinge, and placing the handle in rotated position.

FIG. 13 is a zoom in view of the first version of the removable handle with locking pin.

FIG. 14 is a zoom in view of the first version of the removable handle with locking pin removed and handle removed.

FIG. 15 is a zoom in view of the second version of the removable handle with locking pin.

FIG. 18 is a zoom in view of the second version of the removable handle with a second version of locking pin removed and handle removed.

FIG. 17 is an isometric view of the grill.

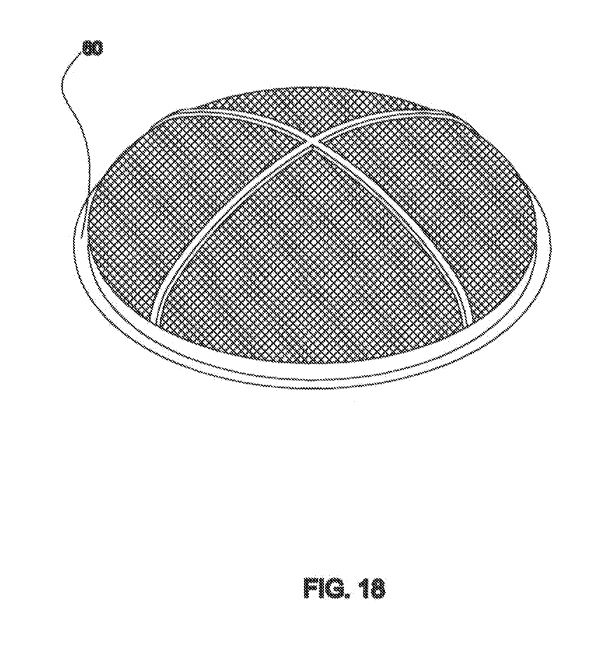

FIG. 18 is an isometric view of the spark arrestor cover.

### DESCRIPTION OF THE PREFERRED EMBODIMENT

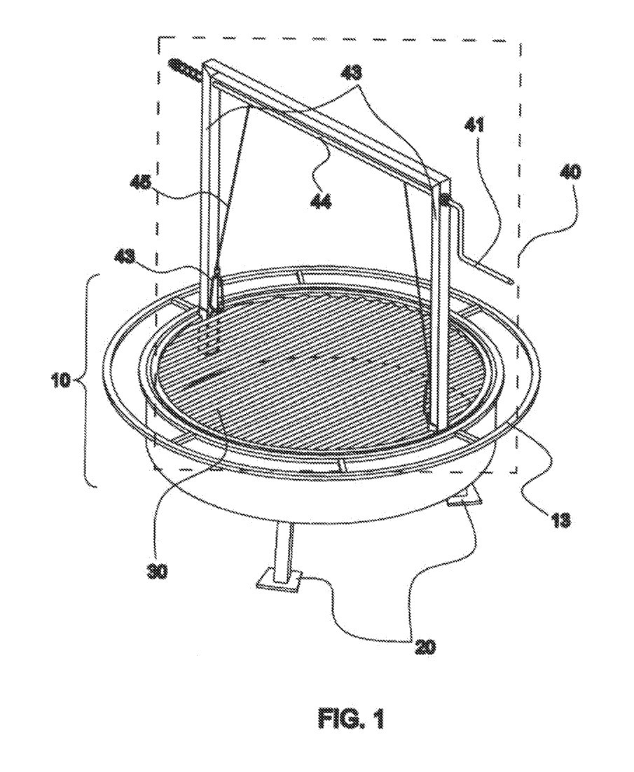

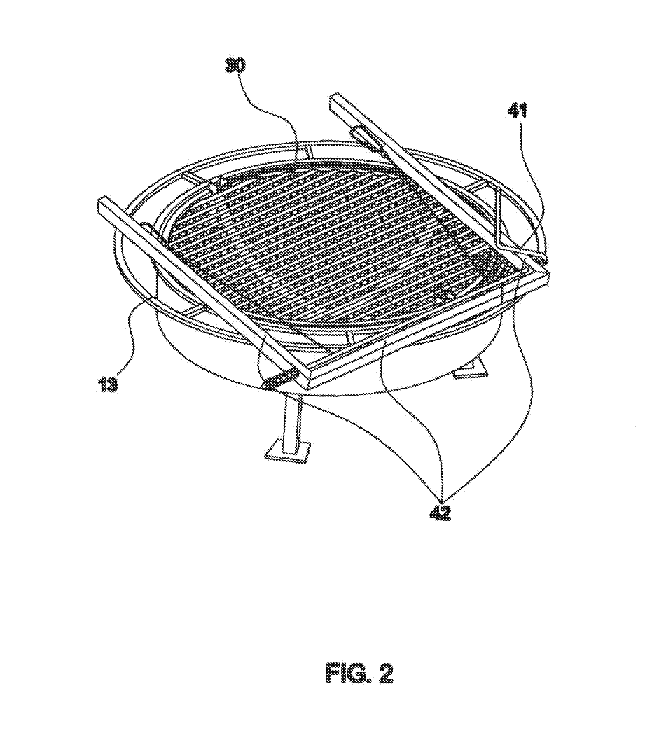

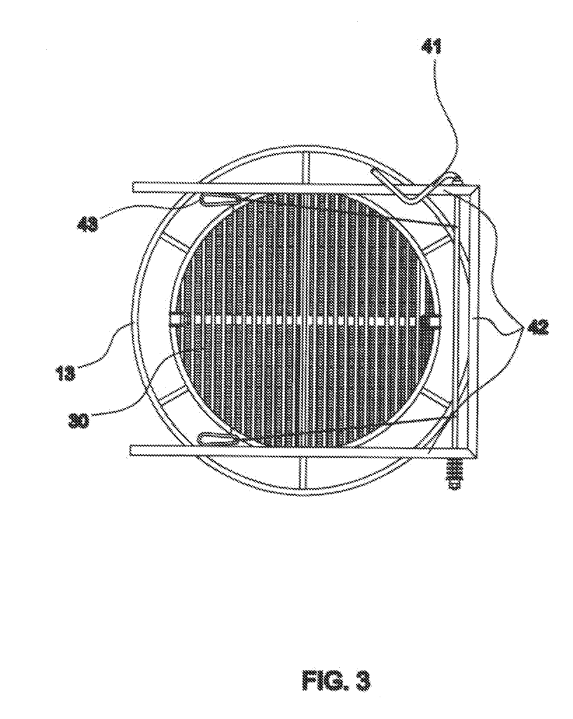

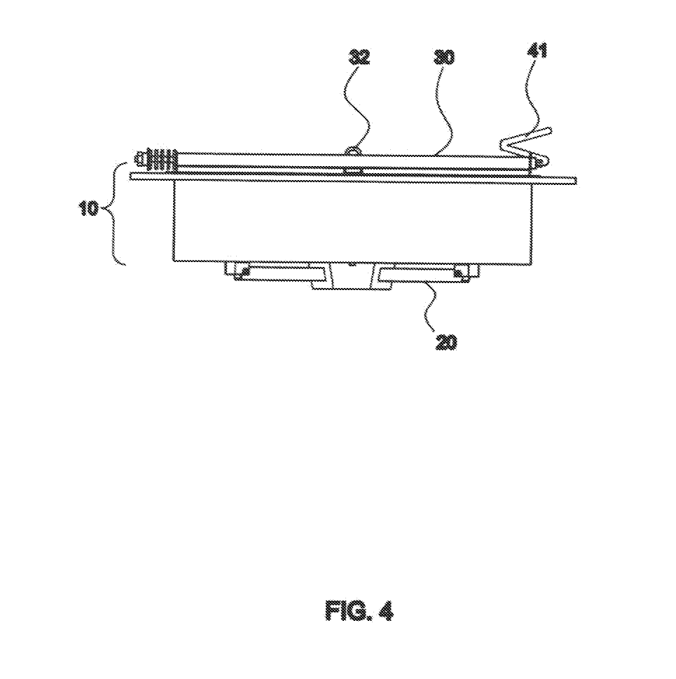

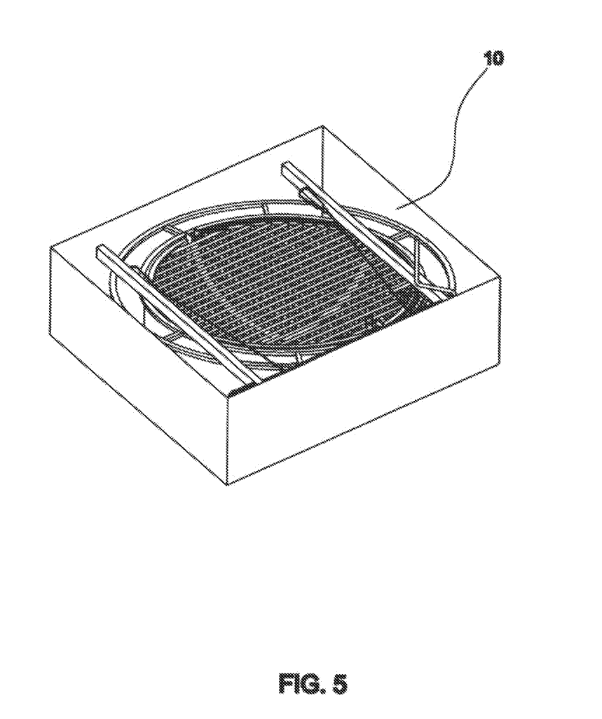

Referring to FIGS. 1-5, there is disclosed the collapsible grill and fire pit in one assembly 100. The collapsible grill and fire pit in one assembly 100 constructed in accordance with the present invention is generally indicated by the number 100. In use, the collapsible grill and fire pit in one assembly 100 would be set up essentially as shown in FIG. 1, with a supply of charcoal or wide range of up to 22 inch split hardwoods (to get different flavors). FIGS. 2-4 show the isometric view, top view, side view of the collapsible fire pit and grill assembly 100 in a folded stowed position. FIG. 5 shows that the collapsible grill and fire pit assembly is stored in a box.

Collapsible fire pit and grill assembly 100 comprises a fire pit 10 for a contained fire, a grill 30 for cooking, and a rotational pulley system 40 for adjusting the distance from the grill 30 to the top of the fire pit 10. The assembly 100 further comprises supporting means 30 such as legs to support fire pit 10 so that even the fire pit 10 is heated it won't damage the ground.

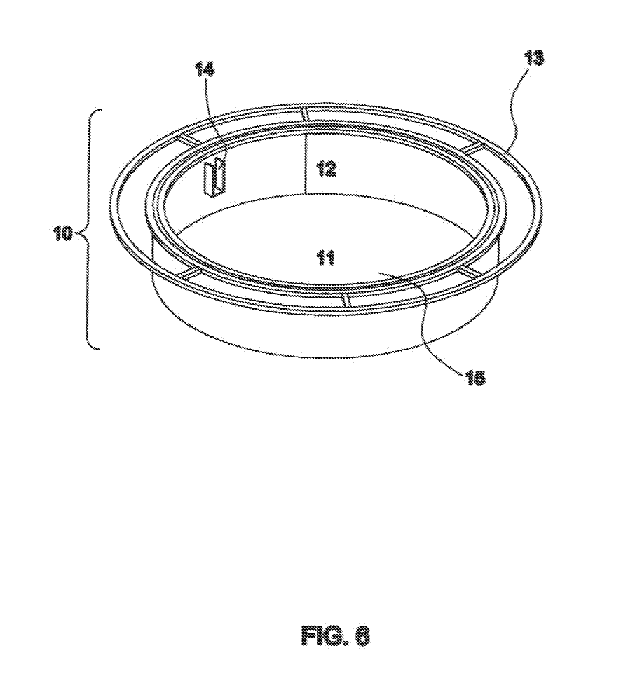

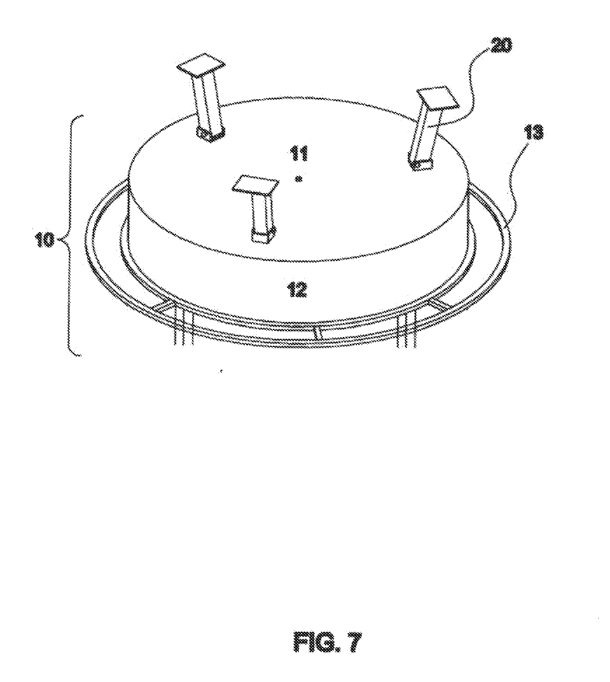

Collapsible fire pit and grill assembly 100, includes a fire pit 10, preferably made of steel. The fire pit 10 is used as a fire pit for receiving combustibles. Referring to FIG. 6 for one preferred embodiment of the fire pit 10 wherein the fire pit 10 looks like a conventional flat base opened top pot with a flange around the top edge. The fire pit 10 is of a cylindrical shape (fire pit approximately 7″ in height) having a solid round base 11, a round side wall 12 projecting perpendicularly and upwards from the base along the circumferential edge of the base, a flange 13 projecting horizontally and outwards from the top edge of the circular side wall, a pair of brackets 14 located opposite to each other on the side wall's interior surface; wherein the base and side wall defines a opened top chamber 15 for receiving charcoal, woods, and any other combustibles. In the preferred embodiment, the fire pit 10 is approximately 7 inches in height. The fire pit 10 may have other shapes in other embodiments.

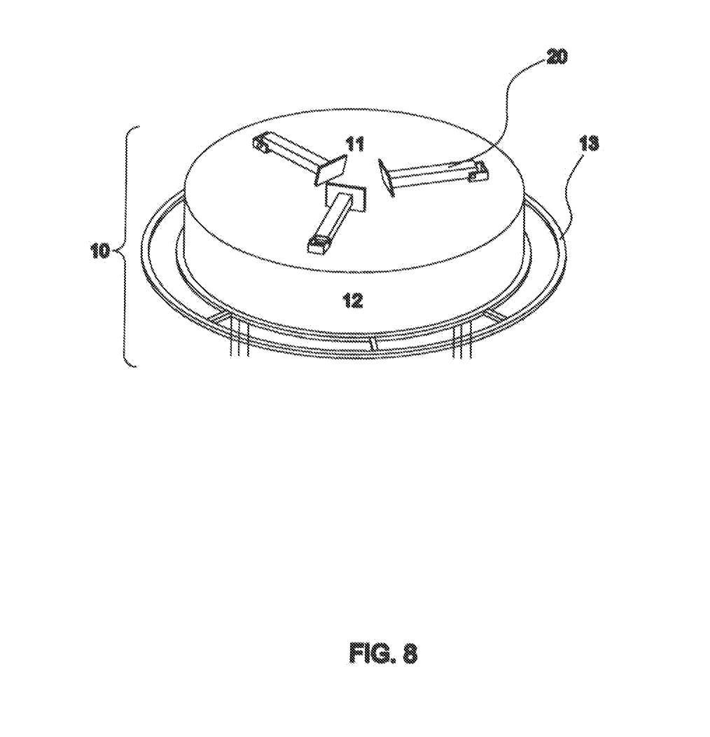

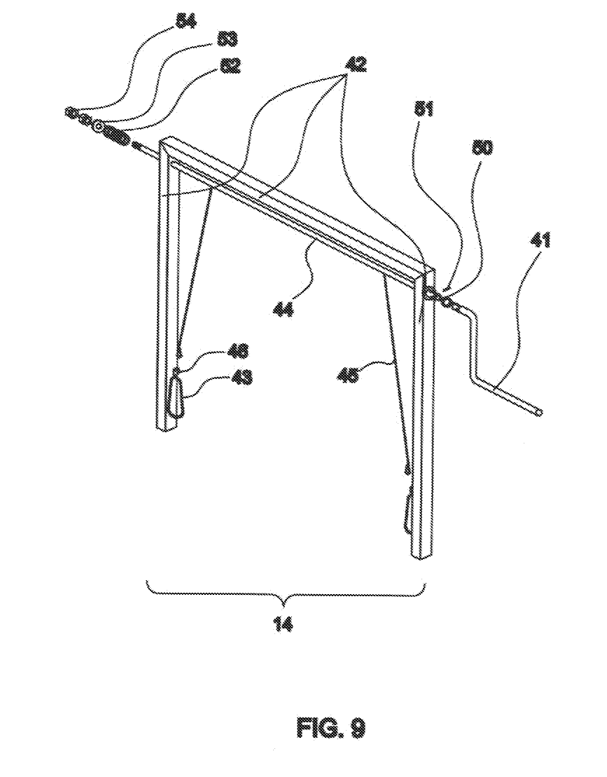

In order to avoid the heated fire pit 10 to directly contact with any surface including ground to cause damage to the surface due to hot burning temperature, legs 20 are provided to support the fire pit 10 and keep it away from direct contact with the ground. In the preferred embodiment that is shown in FIG. 7, three legs 20 are attached to the exterior side of the base 11 of the fire pit 10 via brackets, bolts, and nuts to create the hinges for the legs 20 to be mounted on the fire pit's base 11 at a 10 degree angle tilted from the plane perpendicular to the base 11. The legs 20 may be rotated against the fire pit so it can be folded against the base 11 of the fire pit 10 to conserve space and for easier transportation. In other embodiment, more than three legs are available as shown in FIG. 8.

The collapsible grill and fire pit assemble 100 further comprise a grill 30 which is made of steel. FIG. 17 shows an illustration of the removable grill 30. The removable grill 30 sized to fit over the top of the chamber 15 is employed for cooking. The grill 30 has two sleeves 31, opposite to each other on the edge of the grill, and two hooks 32 near the brackets sleeves 31 respectively.

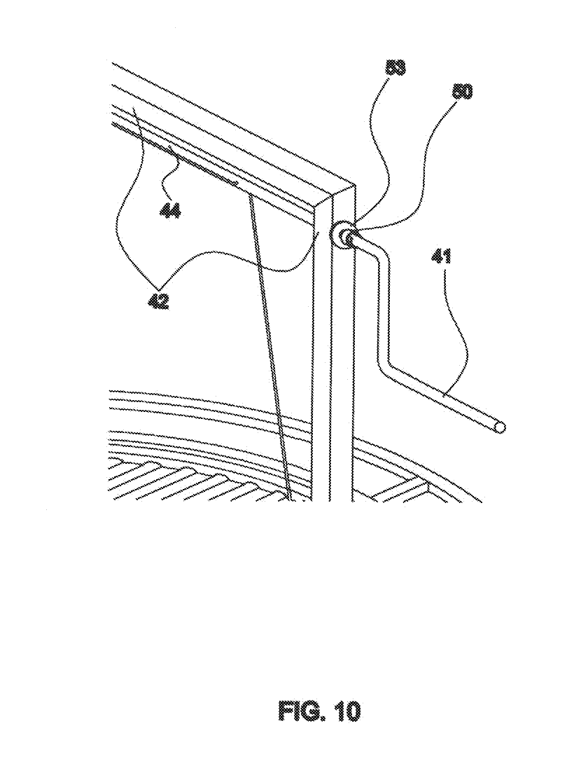

FIGS. 9-10 show a rotational pulley system 40 having a U-shaped frame 42 with a horizontal section, two parallel vertical sections, a horizontal shaft located below the horizontal section across and beyond the two parallel sections, and a handle 41 removably attached to one end of the shaft 44 and two connectors 43 located on the vertical sections respectively for hooking up the hooks 32 on the grill. The shaft 44 has four holes on its body. The cable 45 passes through the two entry holes. The cable's 45 two terminal ends exit from the exit holes to attach to the two connectors 43 respectively. The rotational pulley system further comprises two clamps 46 for securing the two ends of the cable 45 in place. The cable/wire is about 0.09 inches in diameter and 0.58 inches long.

When the grill and fire pit assembly of the present invention is to be used as a grill, the grill 30 is placed over the top of fire pit with the sleeves 31 of grill 30 aligned with the brackets 14 on the fire pit 10 so that the vertical sections are inserted through the sleeves 31 on the grill into the pair of brackets 14 located opposite to each other on the fire pit's side wall's 12 interior surface.

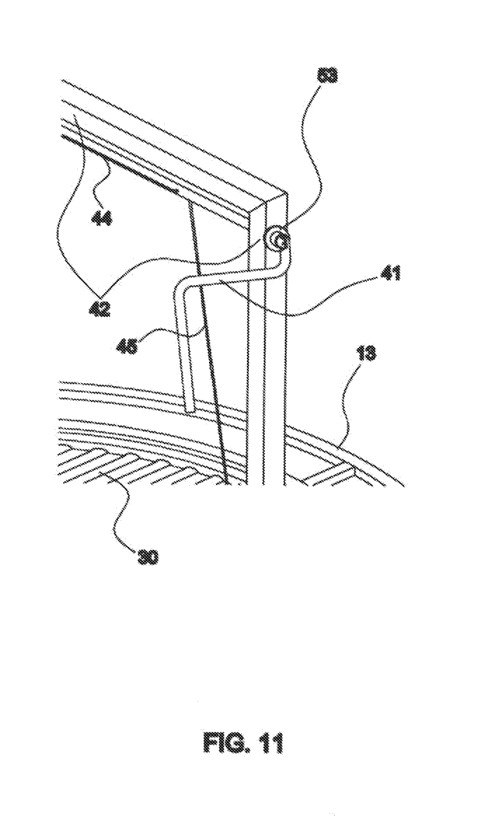

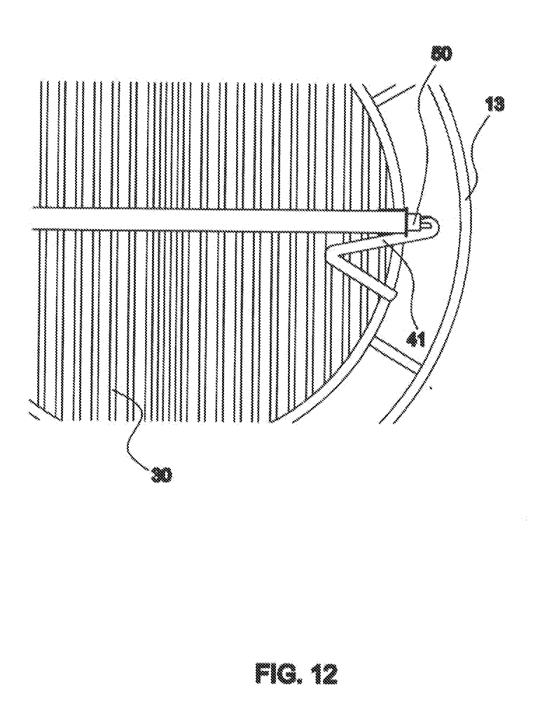

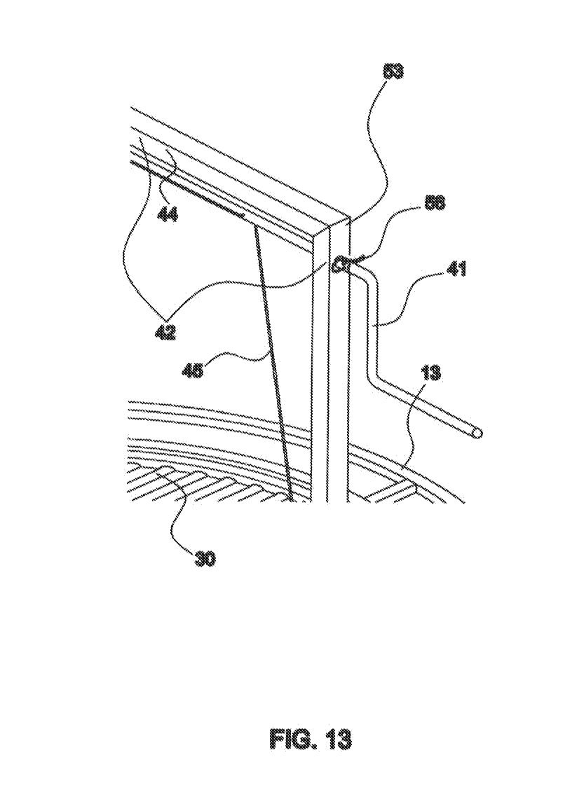

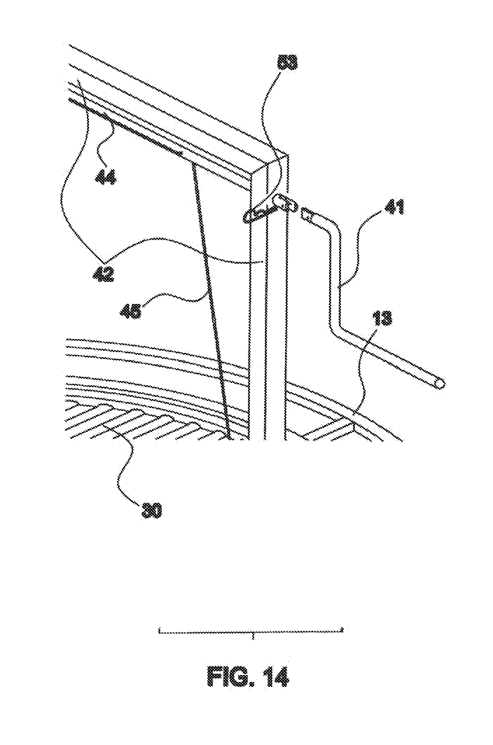

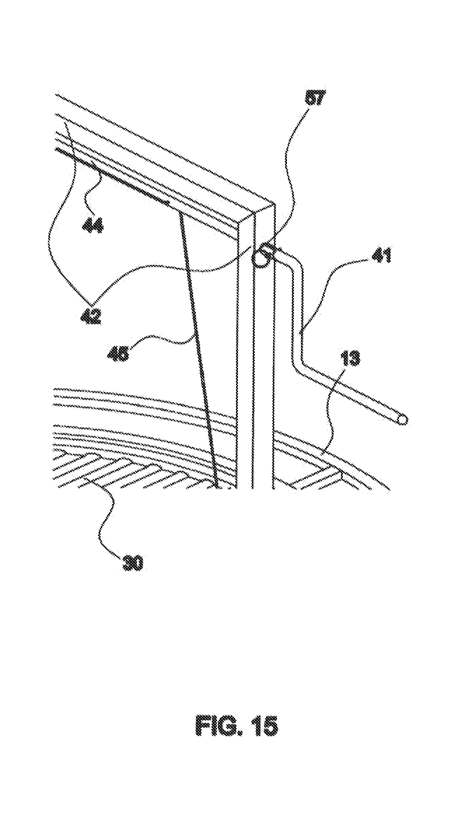

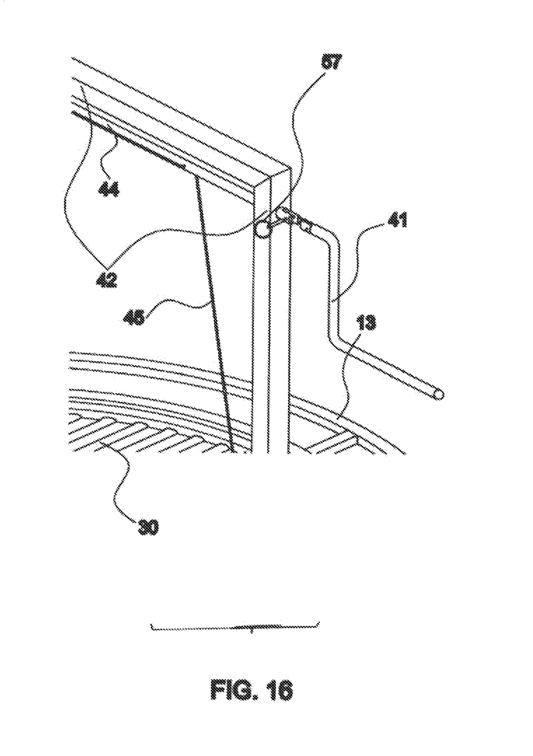

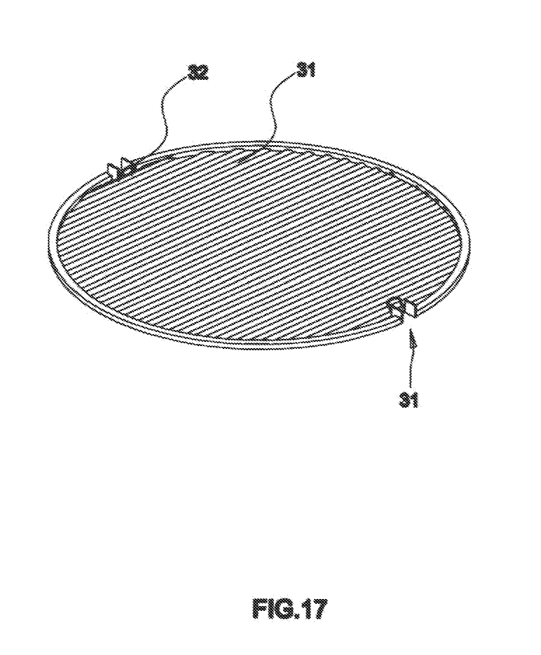

On the U-shaped frame 42, at the points right under where the horizontal section connects with the two parallel vertical sections there are two holes large enough for a shaft 44 to pass through, in one embodiment, the shaft 44 is attached to a handle 41 on the first end. A dowel 51 (⅛″ diameter 0.5″ long), steel washer 53 (⅜″ OD 0.09 thick), and a collar 50 (handle lock) is used to attach the shaft 44 to the handle 41. When the collar 50 is pushed back into locking position, the hinge 55 is exposed. The hinge 55 allows the handle 41 to be rotated to a stowed position. FIG. 11 is a zoomed in isometric view showing the handle 41 in rotated position. FIG. 12 is a zoomed in top view showing the handle 41 in the rotated position. FIG. 13 shows another embodiment, where a removable handle 41 is used. Instead of using a locking collar 53, a locking pin 56 is used. FIG 14 shows that the locking pin 56 can be removed to remove the handle 41. FIG 15 and FIG 16 shows a second type of removable handle 41 with a different shaped locking pin. For both types of removable handle 41, the shaft 44 has a concaved receiving end for the handle 41. Both the concaved receiving end and the handle 41 have corresponding holes that when lined up allows for the locking pin 56 (locking pin 57 in second type) to pass through to lock the handle 41 to the shaft 44 or removed for the locking pin 56 and the handle 41 to detach. The first type of locking pin 56 is shaped so that its loop can encircle the handle 41.

On the other end of the shaft 44 a spring 52 (1.25 O.D×0.170 Wire Diameter, 3″ long) is placed over the shaft 44 to provide friction. A steel washer 53 (1⅜″ OD 0.09 thick) along with a nut 54 (⅜-16 HEX) keeps the spring 52 in place on the shaft 44 and prevent the shaft 44 from falling out of the hole.

The user turns the handle 5 which rotates the shaft 44, pulling the cables 45 that connected to the grill 30 through the connector 43, lifting the grill 30 up to adjust the distance between the fire and the food being cooked. This also allows for opening for the user to put wood or charcoal into.

After the connectors 43 are detached from the grill hooks 32, the U-shaped frame's two vertical section (beams) may be pulled out from the grill's brackets 31. The whole rotational pulley system 40 may be laid flat on top of the grill 30 and fire pit 10 to save space for stowing away. The fire pit and grill assembly 100 may thus be collapse down to approximately 11 inches in height.

Referring to FIG. 18 there is disclosed a spark arrester cover 60 in a dome shape. The cover 60 is constructed by spot weld wire mesh to inside of frame. The diameter of the cover 60 will be large enough to cover the edge of the grill 30.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A collapsible grill and fire pit in one assembly comprising:
a fire pit having a a solid base, a side wall projecting perpendicularly and upwards from the base along the edge of the base, a flange projecting horizontally and outwards from the top edge of the side wall, a pair of brackets located opposite to each other on the side wall's interior surface; wherein the base and side wall defines a opened top chamber for receiving charcoal, woods, and any other combustibles;
at least three legs hingedly attached to the fire pit's base's exterior side for supporting the fire pit, the legs can be folded against the base to conserve space when in stowed position for easy storage and transportation; a removable grill sized to fit over the top of the chamber for cooking having two sleeves, opposite to each other on the edge of the grill, and two hooks near the brackets sleeves respectively; and
a rotational pulley system having two connectors to hook up with the hooks on the grill for converting the fire pit to a fully adjustable cook height grill.

2. The collapsible grill and fire pit in one assembly of claim 1, wherein the pulley system having a U-shaped frame with a horizontal section, two parallel vertical sections, a horizontal shaft located below the horizontal section across and beyond the two parallel sections, a handle removably attached to one end of the shaft, two connectors located on the vertical sections respectively for hooking up the hooks on the grill, a cable going through the shaft with two terminal ends attached to the two connectors respectively, and a clamp for securing the cable in place; wherein the vertical sections are inserted through the sleeves on the grill into the pair of brackets located opposite to each other on the fire pit's side wall's interior surface.

3. The collapsible grill and fire pit in one assembly of claim 2, wherein the pathway of each of the sleeves on the grill aligned with the pathway of each of the brackets when the grill is properly placed over the top of the fire pit.

4. The collapsible grill and fire pit in one assembly of claim 3, wherein the vertical sections are inserted through the sleeves on the grill into the brackets on the fire pit respectively, and the connector are hooking up the hooks on the grill respectively, wherein the handle is turned to rotate the shaft, pulling the cable that connected to the connector and lift the grill up to adjust the distance between the grill and the fire it.

5. The collapsible grill and fire pit in one assembly of claim 4, the handle is attached to the shaft an a first end using a dowel (⅛″ diameter 0.5″ long), a steel washer (⅜″ OD 0.09 thick), and a locking collar (handle lock); wherein the collar is pushed back into the locking position, exposing the hinge; the hinge allows the handle to be rotated to a stowed position.

6. The collapsible grill and fire pit in one assembly of claim 4, wherein the handle is attached to the shaft at a first end using a dowel (⅛″ diameter 0.5″ long), a steel washer (⅜″ OD 0.09 thick), and a locking pin; wherein the shaft has a receiving end for the handle, both the receiving end and handle have corresponding holes that when lined up allow for the locking pin to pass through to lock the handle to the shaft or removed for the locking pin and the handle to detach.

7. The collapsible grill and fire pit in one assembly of claim 5, wherein at the other end of the shaft a spring (1.25 O.D×0.170 Wire Diameter, 3″ long) is placed over the shaft to provide friction, a steel washer (1⅜″ OD 0.09 thick) along with a nut (⅜-16 HEX) keeps the spring in place on the shaft and prevent the shaft from falling out of the hole.

8. The collapsible grill and fire pit in one assembly of claim 5, wherein the shaft have four holes on its body that allow two terminal ends of the cable to pass through two entry holes and gets out from two exit holes and attached to the connectors respectively.

9. The collapsible grill and fire pit in one assembly of claim 1 wherein the fire pit has a shallow cylindrical shape.

10. The collapsible grill and fire pit in one assembly of claim 1 further comprising a spark arrester cover 60 in a dome shape which is constructed by spot weld wire mesh to inside of frame wherein the cover's 60 diameter will be large enough to sit on the edge of the grill.
